(19) United States
(12) Patent Application Publication
(10) Pub. No.: US 2006/0123344 A1
(43) Pub. Date: Jun. 8, 2006

(54) Systems and methods for providing a presentation framework

(75) Inventors: Alla Volkov, Netanya (IL); Orit Harel, Kadima (IL); Ziv Holzman, Tel-Aviv (IL); Bernd Ernesti, Wiesloch (DE); Oliver Radmann, Hoffenhardt (DE)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: SAP AKTIENGESELLSCHAFT

(21) Appl. No.: 11/004,934

(22) Filed: Dec. 7, 2004

(51) Int. Cl. G06F 17/00

(52) U.S. Cl. 715/730

(57) ABSTRACT

Systems, methods and computer readable media are disclosed for rendering content to a display screen of one device of a plurality of devices utilizing an application run by a system. Such systems and methods may identify the one device from among the plurality of devices. Attributes of the screen of the one device may then be received. A template for the screen may be retrieved based on the received attributes. The screen content may be received from the application and mapped into the template. The mapped content may then be rendered to the device for display on the screen.

### BACKGROUND OF THE INVENTION

I. Field of the Invention

The present invention generally relates to data processing and a framework for the presentation of data. More particularly, the invention relates to systems, methods and computer readable media for customization of user interfaces, and for rendering user interfaces so as to be suitable for display on a variety of display screens.

II. Background Information

In an enterprise software application, such as a warehouse management enterprise (WME) application, workers may use a variety of distributed presentation devices to perform transactions with a central execution system. For instance, warehouse workers may use barcode or radio-frequency identification (RFID) scanners to inventory stock or to track the movement of stock within a warehouse.

When taking stock from a bin in a warehouse (a picking transaction), for example, a worker may use a scanner to scan a bar code or RFID located on the stock itself (a stock identifier) as well as a bar code or RFID located on the bin (a source identifier). Once the worker has scanned these items, the information may be transmitted to the execution system, which may then update a database to indicate that the particular stock is no longer located in the particular bin. As another example, when placing stock into a bin (a putaway transaction), the worker may scan the stock identifier and a destination identifier for the stock's new location. This information may again be transmitted to the execution system, which may then update the database to reflect the new location of the stock.

The presentation devices (e.g., scanners, etc.) used within an enterprise software application may be of various types. For instance, some warehouse workers may use mobile, hand-held scanners while others may use stationary terminals with hand-held wands. Further, presentation devices of the same general type may have been acquired at different times and from different manufacturers.

Thus, the various presentation devices in a typical enterprise software application may have different user interfaces. That is, the various presentation devices may have display screens of different types and dimensions. For example, some presentation devices may have graphical (GUI) display screens while other presentation devices may only be capable of displaying character data. Further, display screens of the same type may have different dimensions. For example, some display screens may be 8×40 characters while other display screens may be 16×20 characters.

However, each of the various presentation devices in the enterprise must be capable of performing transactions with the same execution system. In existing systems, the software used by an enterprise to manage each type of transaction needs to be specialized for each type of user interface. In other words, the transaction software must be customized to provide specialized display data required for each type of user interface. But in a large enterprise, which may use many different types of presentation devices, such a solution results in substantial inefficiencies because any upgrade to the transaction software must necessarily also require upgrading the software that provides the data to each of the user interfaces of the various presentation devices in the enterprise.

Further, the various presentation devices may be used by different workers at different times. For example, a particular presentation device may be used by one worker during one shift and by a different worker on the next shift. However, each worker who uses a particular presentation device may have different preferences. For example, different workers may prefer different layouts of function pushbuttons provided by the enterprise software application. At present, such customization is not available. Thus, existing systems result in less than optimal efficiency because each user must adapt themselves to the execution system, rather than the execution system providing the capability to adapt itself to meet the needs and preferences of the individual users.

In view of the foregoing, there is a need for systems, methods and computer readable media for rendering a user interface so as to be suitable for display on a variety of physical display screens. There is also a need for improved systems, methods and computer readable media for customizing displays within an enterprise environment.

### SUMMARY OF THE INVENTION

Consistent with embodiments of the present invention, systems, methods and computer readable media are disclosed for rendering a user interface so as to be suitable for display on a variety of physical display screens.

In accordance with one embodiment, a method performed by a computer system is provided for rendering content to a display screen of one device of a plurality of devices utilizing an application run by a system. The method may comprise: identifying the one device from among the plurality of devices; receiving attributes of the screen of the one device; retrieving a template for the screen based on the received attributes; receiving screen content from the application; mapping the received screen content into the template; and rendering the mapped content to the device for display on the screen.

In accordance with another embodiment, a computer system is provided for rendering content to a display screen of one device of a plurality of devices utilizing an application run by the system. The system may comprise: means for identifying the one device from among the plurality of devices; means for receiving attributes of the screen of the one device; means for retrieving a template for the screen based on the received attributes; means for receiving screen content from the application; means for mapping the received screen content into the template; and means for rendering the mapped content to the device for display on the screen.

In accordance with another embodiment, computer-readable media containing instructions for performing a method for rendering content to a display screen of one device of a plurality of devices utilizing an application run by a system is provided. The method contained by the computer-readable media may comprise: identifying the one device from among the plurality of devices; receiving attributes of the screen of the one device; retrieving a template for the screen based on the received attributes; receiving screen content from the application; mapping the received screen content into the template; and rendering the mapped content to the device for display on the screen.

In accordance with another embodiment, a method for rendering content to respective display screens of a plurality of devices utilizing an application run by the system, wherein the display screens include at least one of display screens of different types and a display screens of different dimensions, is provided. The method may comprise: providing a template data structure defining one or more data fields for displaying rendered content on a display screen of a particular type and size; receiving an indication of the type and size of the display screen of a particular device; retrieving the template data structure for the screen based on the received type and size; generating screen content; translating the generated screen content, based on the template data structure, to a format compatible with the respective display screens of the plurality of devices; and rendering the translated content on the display screens of the plurality of devices.

In accordance with another embodiment, a system for rendering content to respective display screens of a plurality of devices utilizing an application run by the system, wherein display screens include at least one of display screens of different types and a display screens of different screen dimensions, is provided. The system may comprise: a user interface layer for receiving user input data from the plurality of devices and for rendering content to the plurality of devices in a format compatible with the respective display screens of the plurality of devices; a template data structure defining one or more data fields for displaying rendered content on a particular display screen of a particular device; a business logic layer for generating content to be rendered to each device by the user interface layer; wherein the user interface layer receives the generated content and translates the generated content, based on the template data structure, to a format compatible with the respective display screens of the plurality of devices.

In accordance with yet another embodiment, a computer-readable medium containing instructions for performing a method for rendering content to respective display screens of a plurality of devices utilizing an application run by the system, wherein the display screens include at least one of display screens of different types and a display screens of different dimensions, is provided. The method contained by the computer-readable media may comprise: providing a template data structure defining one or more data fields for displaying rendered content on a display screen of a particular type and size; receiving an indication of the type and size of the display screen of a particular device; retrieving the template data structure for the screen based on the received type and size; generating screen content; translating the generated screen content, based on the template data structure, to a format compatible with the respective display screens of the plurality of devices; and rendering the translated content on the display screens of the plurality of devices.

It is to be understood that both the foregoing general description and the following detailed description are exemplary and explanatory only, and should not be considered restrictive of the scope of the invention, as described and claimed. Further, features and/or variations may be provided in addition to those set forth herein. For example, embodiments of the invention may be directed to various combinations and sub-combinations of the features described in the detailed description.

### BRIEF DESCRIPTION OF THE DRAWINGS

The accompanying drawings, which are incorporated in and constitute a part of this disclosure, illustrate various embodiments and aspects of the present invention. In the drawings:

FIG. 1 is a diagram of an exemplary enterprise environment, consistent with an embodiment of the present invention;

FIG. 2 illustrates an exemplary framework for an execution system, consistent with an embodiment of the present invention;

FIG. 3 illustrates exemplary components of a screen display, consistent with an embodiment of the present invention;

FIGS. 4 and 5 are flow diagrams illustrating exemplary methods, consistent with embodiments of the present invention; and

FIGS. 6A-E illustrate exemplary screen displays, consistent with embodiments of the present invention.

### DETAILED DESCRIPTION

The following detailed description refers to the accompanying drawings. Wherever possible, the same reference numbers are used in the drawings and the following description to refer to the same or similar parts. While several exemplary embodiments and features of the invention are described herein, modifications, adaptations and other implementations are possible, without departing from the spirit and scope of the invention. For example, substitutions, additions or modifications may be made to the components illustrated in the drawings, and the exemplary methods described herein may be modified by substituting, reordering, or adding steps to the disclosed methods. Accordingly, the following detailed description does not limit the invention. Instead, the proper scope of the invention is defined by the appended claims.

Systems and methods consistent with embodiments of the present invention facilitate the rendering of user interfaces so as to be suitable for display on a variety of physical display screens. By way of example, embodiments of the invention may be used for rendering displays of an enterprise software application, such as a warehouse management application, so as to be suitable for display on screens of various dimensions and types, e.g., graphical or character. As further disclosed herein, embodiments of the invention also provide for the customization of displays and transactions within an enterprise software application, in order to meet the needs of a content provider, such as a warehouse enterprise.

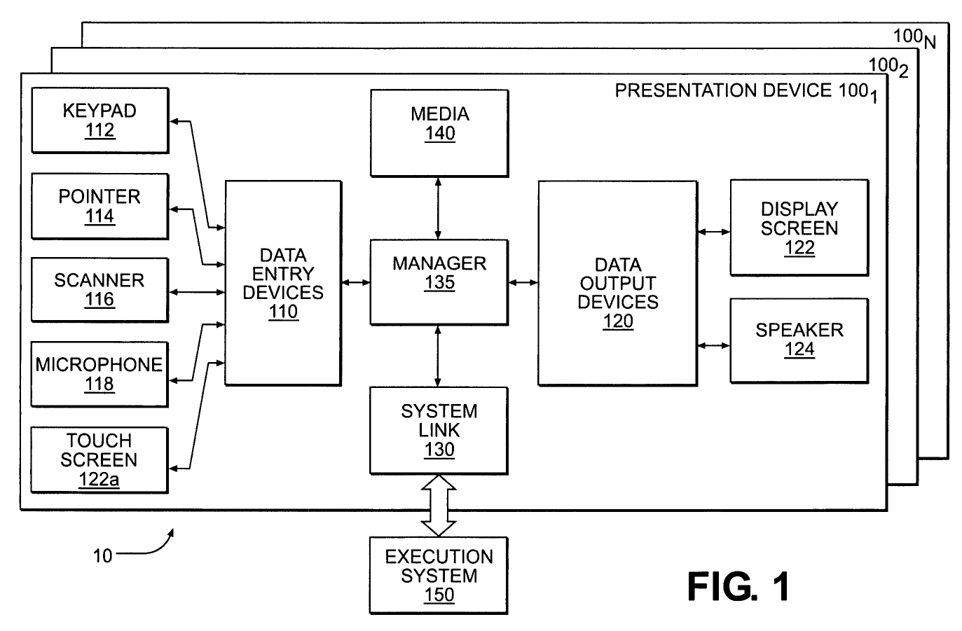

FIG. 1 illustrates an exemplary enterprise environment 10, such as a warehouse management enterprise (WME) environment, consistent with an embodiment of the present invention. As shown in FIG. 1, enterprise 10 may include a plurality of presentation devices 100_{1-N} linked to an execution system 150. Presentation devices 100 may interact with execution system 150 in order to complete transactions within an enterprise software application, such as a warehouse management application.

Each presentation device 100 may include one or more data entry devices 110 for entering data or commands during transactions with execution system 150. Data entry devices 110 may include, for example, a text or numeric keyboard or keypad 112 (which may include function keys or other buttons), a pointer 114, such as a mouse, track ball, touch pad, etc., a bar code or radio-frequency identification (RFID) scanner 116, and/or a microphone 118 linked to appropriate voice-recognition software.

Each presentation device 100 may also include one or more data output devices 120 for presenting data to a user. Data output devices 120 may include, for example, a display screen 122 and/or a speaker 124. In an exemplary embodiment of the present invention, display screen 122 may include a touch screen 122a, such that the area of screen 122 may be used for both data entry and data presentation. For example, touch screen 122a may be used to provide pushbuttons for initiating functions of the enterprise software application. Touch screen 122a may also be linked to appropriate software for interpreting a user's handwriting. Presentation device 100 may also include a system link 130, such as an antenna and/or a network cable and appropriate modem (not shown), for linking presentation device 100 with execution system 150.

Each presentation device 100 may further include a presentation device manager 135 operatively linked to data entry device(s) 110, data output device(s) 120, and/or system link 130. Manager 135 may manage the transfer of data from data entry devices 110 to execution system 150 via system link 130. Manager 135 may also manage the distribution of content received from system 150 to data output devices 120.

Manager 135 may be implemented, e.g., by a processor that executes an appropriate presentation device management program carried by presentation device media 140. Presentation device media 140 may include any appropriate computer readable media or medium, such as, e.g., memories (e.g., RAM or ROM), secondary storage devices (e.g., a hard disk, floppy disk, optical disk, etc.), a carrier wave (e.g., received from execution system 150 via system link 130), etc.

In an exemplary embodiment of the present invention, each presentation device 100 may be implemented using a mobile RFID scanner, a barcode scanner, or any other type of scanner used, for example, to inventory stock or to track the movement of stock within a warehouse. However, presentation device 100 may be implemented using any appropriate type of user interface device, such as a personal or network computer, personal digital assistant (PDA), cellular telephone, etc.

Execution system 150 may execute an enterprise software application, such as a warehouse management application compatible with, for example, the R/3 application system provided by SAP Aktiengesellschaft, Walldorf, Germany. System 150 may be implemented using a computer-based platform, such as a computer, a workstation, a laptop, a server, a network computer, or the like.

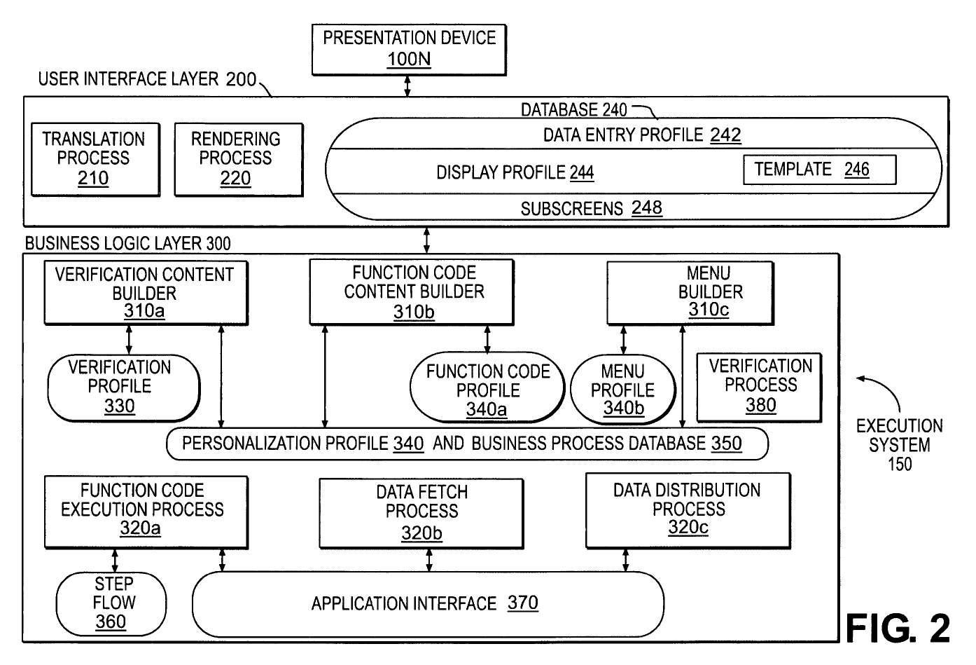

FIG. 2 illustrates an exemplary framework for execution system 150, consistent with an embodiment of the present invention. As shown in FIG. 2, system 150 may include a user interface layer 200 for rendering a user interface to presentation devices 100, and a business logic layer 300 for executing the business logic of the enterprise software application.

User interface layer 200 may be separate from the business logic layer 300. That is, business logic layer 300 may be solely responsible for the execution of the business logic, and user interface layer 200 may be solely responsible for rendering the user interface. For example, user interface layer 200 and business logic layer 300 may be contained in distinct modules within execution system 150. In this manner, user interface layer 200 and business logic layer 300 may be updated and modified independently of each other.

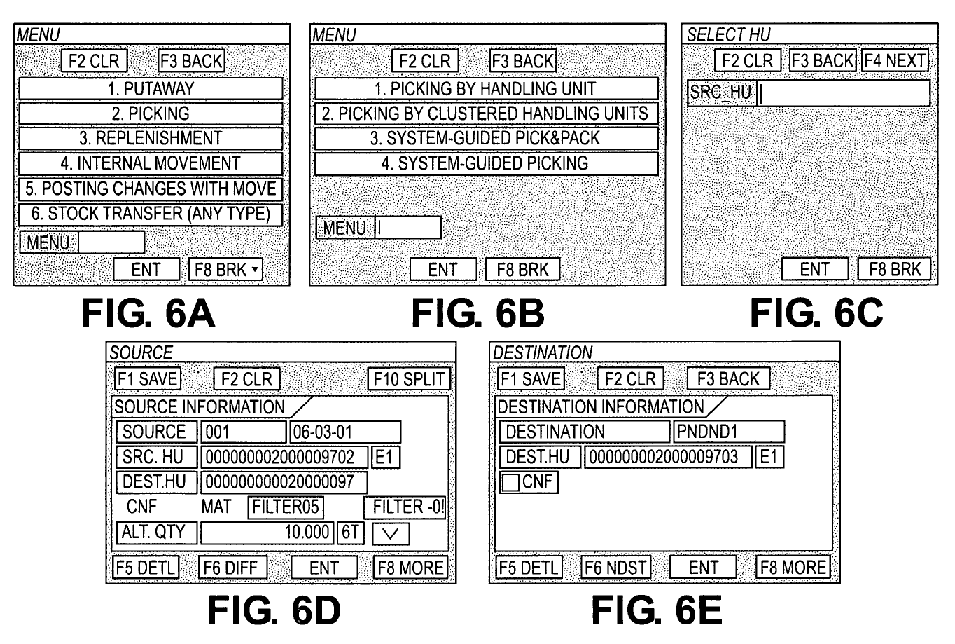

In a warehouse management application, user interface layer 200 may render user interfaces designed to facilitate entry of data necessary to inventory stock or to track the movement of stock within a warehouse. As illustrated in FIGS. 6A-6E, for instance, user interface layer 200 may render user interfaces designed to facilitate the completion of picking and/or putaway transactions. The flow of steps within each transaction may be controlled by business logic layer 300.

In a picking transaction, for example, a worker may use data entry devices 110 of a presentation device 100 to enter a source and destination identifiers into appropriate fields of the user interface. Once the worker has entered these items, the information may be transmitted to business logic layer 300, which may then update a database to indicate that the particular stock is no longer located in the particular bin. As another example, in a putaway transaction, the worker may use data entry devices 110 of presentation device 100 to enter the source and destination identifiers for the stock's new location. This information may again be transmitted to the business logic layer 300, which may then update the database to reflect the new location of the stock. The operation of execution system 150 is further explained below.

User interface layer 200 may include software for operating the user interface for the enterprise software application. For example, user interface layer 200 may include a translation process 210 for translating data received from data entry devices 110 to a format appropriate for input to business logic layer 300. User interface layer 200 may also include a rendering process 220 for building and rendering physical screen data, i.e., graphical or character data, in a format appropriate for output by output devices 120.

In an exemplary embodiment of the present invention, user interface layer 200 may also maintain a database 240. Although database 240 is illustrated in FIG. 2 as a single entity or database, the data contained in database 240 may instead be distributed between a plurality of databases. Database 240 may contain, for example, a data entry profile 242, a display profile 244, and sub-screens 248.

User interface layer 200 may access data in data entry profile 242 and display profile 244 in order to customize the user interface for the particular presentation device. Profiles 242 and 244 may define one or more physical attributes of a particular presentation device 100_{N} (or particular group of presentation devices, e.g., all of the presentation devices 100_{1-N} having a particular model number) supported by execution system 150. Data entry profile 242 may define the type of data entry device(s) 110 (e.g., keyboard, mouse, barcode scanner, RF scanner, voice recognition, and/or touch screen, etc.) available on the particular presentation device 100_{N}. Display profile 244 may define the type of output device(s) 120 (e.g., display screen and/or speaker, etc.) available on the particular presentation device 100_{N}.

For example, display profile 244 may include one or more records that define the type of screen 122 (e.g., character or graphic) and/or the dimensions of screen 122 (e.g., the height and width, expressed, e.g., in characters or pixels, etc.). Display profile 244 may also contain a template 246 corresponding to the type and dimensions of the display screen 122 of the particular presentation device ¹⁰⁰N defined in display profile 244. Alternatively, display profile 244 may contain a pointer to template 246. Template 246 may define one or more data fields of display screen 122.

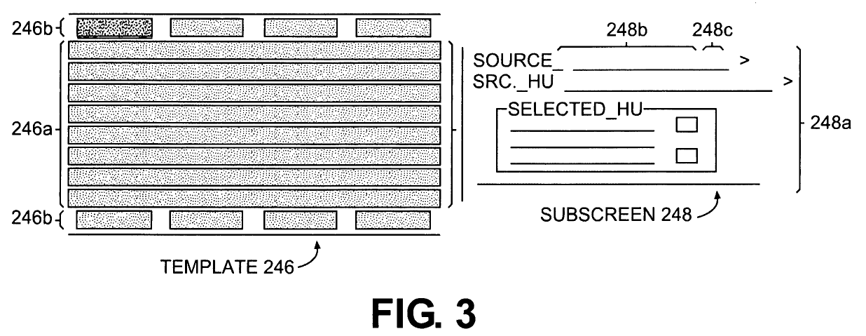

As shown in FIG. 3 (discussed further below) template 246 may define one or more graphical or character areas 246a available for use in displaying graphical or character information, depending on the type of the particular screen 122. Template 246 may also define one or more function areas 246b available for use in displaying function codes within keypad 112 or pushbuttons within touch screen 122a. Template 246 may be implemented, e.g., using the Dynpro or Web Dynpro applications available from SAP AG, Walldorf, Germany.

The data entry profile 242 and display profile 244 for a particular presentation device 100_{N} may be obtained automatically, e.g., from a database made available by a manufacturer of the particular presentation device 100_{N}. Alternatively, profiles 242 and 244 may be manually entered by a user, e.g., using data entry devices 110 of the particular presentation device 100_{N}.

User interface layer 200 may access data in sub-screens 248 in order to render an appropriate user interface for the particular transaction step. Sub-screens 248 may be provided for each transaction step that is executed in the foreground (i.e., executing the transaction step by the presentation of a display to a user via a display screen 122). As shown in FIG. 3, for example, sub-screens 248 may define preset character or graphical content 248a for a display associated with a particular transaction step or steps. Sub-screens 248 may also define one or more output fields 248b (e.g., fields reserved for the display of data passed from business logic layer 300) and/or one or more verification fields 248c.

The content provider, such as a warehouse, may create sub-screens 248, e.g., using data entry devices 110 of a presentation device 100 linked to execution system 150. For example, the enterprise software application may be provided with a screen maintenance tool that may allow an administrator to create, change, copy and delete sub-screens for particular transaction steps of the enterprise software application. In an exemplary embodiment of the present invention, the screen maintenance tool may allow an administrator to convert existing screens from one size to another.

For example, the screen maintenance tool may be configured to convert a screen of one size (e.g., 8×40) and/or type (e.g., GUI) into another format. The conversion may involve a change in the inclusion or the position of one or more screen elements, in the size of the text, in the number of pushbuttons, etc. The screen maintenance tool may also allow an administrator to create new screens, and to link the new screens to transactions within the enterprise software application.

Business logic layer 300 may include a verification content builder 310a, a function code content builder 310b and a menu builder 310c (collectively, “content builders 310”) for building and generating data related to the user interface for a particular transaction step and transmitting such data to user interface layer 200. Business logic layer 300 may also include a function code execution process 320a, a data fetch process 320b and a data distribution process 320c (collectively, “transaction processes 320”) for executing the steps of each transaction (e.g., picking, putaway, etc.) supported by the enterprise software application. In an exemplary embodiment of the present invention, business logic layer 300 may also maintain a database (or databases) containing a verification profile 330, a personalization profile 340, a business process database 350, a step flow 360, and/or an applicationinterface 370.

Function code execution process 320a may be responsible for executing the steps of each transaction of the enterprise software application according to the flow of steps defined by step flow 360. Data fetch process 320b may be responsible for fetching data from application interface 370 for use in the completion of transaction steps and/or displays. For example, data fetch process 320b may fetch a source identifier from application interface 370 for use in a validation transaction. Data distribution process 320c may be responsible for distributing data to application interface 370. For example, data distribution process 320c may save a destination identifier from a putaway transaction to indicate the location of stock within a warehouse. The operation of business logic layer is further detailed below.

Verification profile 330 may define a set of fields that the content provider desires to be verified during execution of a particular transaction or group of transactions. For example, verification profile 330 may indicate a particular field that is open for user input and a control field within application interface 370 that contains a control value with which the value in the user input field is to be compared.

Business logic layer 300 may further include a verification process 380 for verifying user input, associated with a field defined by verification profile 330, received from data entry devices 110 via user interface layer 200. When a user enters data into the input field, verification process 380 may then compare the inputted data to the control value provided by application interface 370 to thus verify the data input by the user. Verification process 380 may then provide user interface layer 200 with an indication as to whether the data has been verified.

Verification content builder 310a may access verification profile 330 in order to build appropriate content for a particular transaction step. Business logic layer 300 may provide the verification content (e.g., the identity of particular fields that are to be verified from verification profile 330) built by verification content builder 310a to user interface layer 200. User interface layer 200 may then use the verification content provided by business logic layer 300 to render appropriate content in graphical or character areas 246a of template 246.

Personalization profile 340 may identify a particular user as a member of a particular group of users. For example, personalization profile 340 may identify a particular user's working role (e.g., manager, warehouse worker). Alternatively, personalization profile 340 may identify the particular user. Business logic layer 300 may use personalization profile 340 to link the particular user with profiles that record preferences of a particular user or group of users with respect to the presentation of physical screen data For example, personalization profile 340 may link the particular user with a function code profile 340a and/or a menu profile 340b.

Function code profile 340a may indicate a user's preferred assignment of functions to particular function keys on keypad 112, or pushbuttons on touch screen 122a, during a particular transaction step or group of steps. For example, one user may prefer to assign a particular function to a first pushbutton of a presentation device, while another user may prefer to assign that particular function to another pushbutton of the same type of presentation device. Function code content builder 310b may access function code profile 340a in order to build appropriate function code content for a particular transaction step. Business logic layer 300 may provide the function code content (e.g., text to be displayed in function code areas 246b of template 246) built by function code content builder 310b to user interface layer 200. User interface layer 200 may then use the function code content provided business logic layer 300 to render appropriate content in function code areas 246b of template 246.

Menu profile 340b may indicate a user's preferred layout of menus for the enterprise software application. For example, menu profile 340b may indicate the user's preferred layout for menu items within a main menu (e.g., FIG. 6A) and/or submenus (e.g., FIG. 6B). Menu items may navigate to another menu or initiate a transaction of the enterprise software application at hand. Menu profile 340b may define, for each menu item, text that is to be displayed (e.g., “PICKING,” as in FIG. 6A), a sequence of navigation between menus (e.g., from the menu of FIG. 6A to the sub-menu of FIG. 6B), and the assignment of menu items to transactions. Menu builder 310c may access menu profile 340b in order to build appropriate content for a particular menu. Business logic layer 300 may provide the menu content (e.g., text to be displayed in graphical or character areas of template 246) built by menu builder 310c to user interface layer 200. User interface layer 200 may then use the menu content provided business logic layer 300 to render appropriate content in graphical or character areas 246a of template 246.

A particular user may manually enter their personalizationprofile 340, e.g., using data entry devices 110 of the associated presentation device 100_{N} linked to execution system 150. For example, system 150 may be provided with a menu management transaction module that may allow a user to create, change, copy and delete personalized menus. In an exemplary embodiment of the present invention, for instance, the menu management transaction module may present the user with an object catalog and a menu hierarchy. The menu management transaction module may be configured to allow the user to create or change menus by dragging objects from the catalog and dropping them into the menu hierarchy, or by removing objects from the hierarchy. The enterprise software application may also be provided with a function code management transaction configured to operate in a manner similar to the menu management transaction module.

Function code profile 340a and/or menu profile 340b may be initially populated with default values. These default values may be used where the particular user has not customized a function code profile 340a and/or a menu profile 340b.

Step flow 360 may record the order of steps within a particular transaction or group of transactions executed by business logic layer 300. Step flow 360 may contain a table (not shown) that may indicate, for a given transaction step, the succeeding processing step. Function code execution process 320a may execute the steps of each transaction according to the flow of steps indicated by step flow 360. The flow of steps executed by function code execution process 320a may be dependent upon user input. For example, the flow of steps within a transaction may be varied by the use of function keys or pushbuttons within keypad 112 or touch screen 122a. The outcome of using a function key or pushbutton step may be continuation to the next step in step flow 360 or execution of a specific function (e.g., save an entry, clear an entry, back to the previous display, etc., as indicated in FIGS. 6A-6E).

Step flow 360 may also indicate a transaction to be entered directly after a processing interruption. For example, step flow 360 may indicate that, upon logon, the user is to be returned to the last transaction or transaction step performed prior to the interruption. This would allow the user to recover, e.g., in the event of a loss of communication between presentation device 100_{N} and system 150. Alternatively, step flow 360 may indicate that, upon logon, the user is to enter a particular transaction (e.g., main menu, etc.). Further, step flow 360 may record a particular transaction that the user is to enter directly after the completion of a certain transaction. For example, step flow 360 may indicate that, upon the ending of one transaction, the user is to be returned to the same transaction, return to the main menu, or return to the last sub-menu, etc.

Application interface 370 may include data specific to the particular enterprise software application executed by execution system 150. In a WME application, for example, application interface 370 may include data identifying the various items of stock within the warehouse (stock identifiers) as well as data defining the location of the stock (source identifiers). Business logic layer 300 may use data fetch process 320b to fetch data from application interface 340 in order to complete a transaction step. Business logic layer 300 may also use data distribution process 320c to distribute data generated during a transaction step to applicationinterface 340. During a putaway transaction, for example, data distribution process 320c may record the identifier for the new location of the stock in application interface 370.

Business process database 350 may include data specific to the particular transactions of the enterprise software application. In a WME application, for example, business process database 350 may include data related to, e.g., picking and putaway transactions, etc., such as the identity of the last step of the transaction that was completed by business logic layer 300.

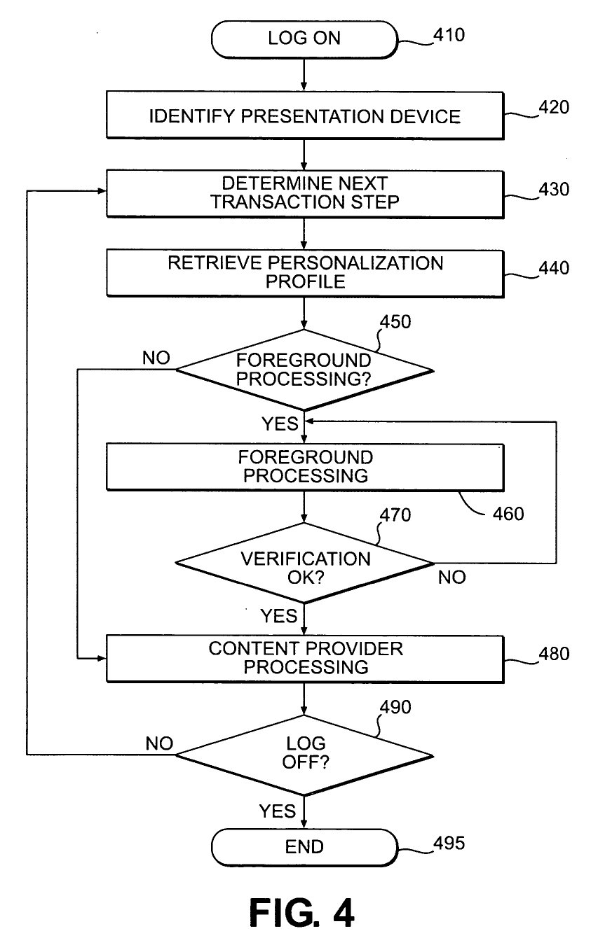

FIG. 4 is a flow diagram of an exemplary method for interaction between a presentation device 100_{N} and execution system 150, consistent with an embodiment of the present invention. The method illustrated in FIG. 4 is described with reference to exemplary screen displays illustrated in FIGS. 6A-E.

The interaction may begin at 410 when a user logs on to execution system 150. In one embodiment, a user may log on to system 150 by switching presentation device 100_{N} to an “on” state. However, in other embodiments, a user may be required to enter data, such as a user name and/or password, via data entry devices 110 in order to complete the logon process. During the logon transaction, business logic layer 300 may instruct user interface layer 200 to render a default logon display designed to be readable on all types and dimensions of display screens 122 supported by execution system 150. Once the user is logged on to the execution system as an active presentation device, the user can use presentation device 100 to request and execute transactions within the enterprise software application.

At 420, execution system 150 may identify the particular presentation device 100_{N}. For example, business logic layer 300 may prompt presentation device 100_{N} to automatically identify itself, e.g., by network address or other identifier, such as an identification number or code. If this prompt is not responded to, business logic layer 300 may prompt the user to manually identify presentation device 100_{N}, e.g., by inputting an identifier. Alternatively—for example, if neither of these prompts are responded to—business logic layer 300 may identify presentation device 100_{N} using a default identifier. The default identifier may be an identifier associated with the particular user or group of users (recorded in, e.g., personalization profile 340), or, alternatively, may be a global default applicable to all users. User interface layer 200 may then retrieve data associated with the particular presentation device 100_{N}. For example, user interface layer 200 may retrieve the type of output device(s) 120 from display profile 244. User interface layer may further retrieve the type of screen 122 and the dimension of screen 122 from display profile 244.

At 430, business logic layer 300 may determine the next transaction step from step flow 360. The next transaction step may correspond to, e.g., a menu, such as a main menu (e.g., FIG. 6A, illustrating an exemplary main menu for a WME application) or sub-menu (e.g., FIG. 6B, illustrating a sub-menu for a picking transaction), the beginning of a transaction, such as picking (e.g., FIG. 6C, illustrating a display for a stock transaction), putaway, etc., or to the continuation of a transaction that was previously begun, e.g., an enter source identifier step (e.g., FIG. 6C) or enter destination identifier step (e.g., FIG. 6E) in a picking transaction.

The next transaction step may be determined in a number of ways. First, the next transaction step may be determined automatically by business logic layer 300. Specifically, business logic layer 300 may compare the identity of the current transaction step (which may have been saved in business process database 350 during a previous iteration of the method) to step flow 360 so as to determine whether step flow 360 specifies a particular next transaction step to be invoked upon completion of the particular last transaction step. For example, step flow 360 may indicate that a particular transaction, e.g., a main menu (FIG. 6A), is to be entered directly after logon. If a particular next transaction step is specified by step flow 360, then business logic layer 300 may invoke the specified next transaction step. In this manner, a user may recover after an interruption of their work, e.g., due to a loss of communication between presentation device 100_{N} and system 150.

Second, the next transaction step may be determined dynamically by the user via data entry devices 110. For instance, the user may select a particular next transaction from a menu of transactions (e.g., FIGS. 6A and B) using, e.g., function keys or pushbuttons within keypad 112 or touch screen 122a. Alternatively, the user may “virtually” navigate across menus by entering a navigation sequence in a “menu” field (see, e.g., FIGS. 6A and 7B). Entry of a navigation sequence may operate to select corresponding menu items from sequential menus. For example, by entering “21” in the menu field in FIG. 6A, the user may select “PICKING” from the main menu (FIG. 6A) and “PICKING BY HANDLING UNIT” from the “PICKING” sub-menu.

At 440, business logic layer 300 may retrieve personalization profile 340 (or portions of personalization profile 340) associated with the particular user (identified by, e.g., a user name entered at logon). Business logic layer 300 may then retrieve the function code profile 340a and/or menu profile 340b associated with the particular user's personalization profile. Business logic layer 300 may use the information in function code profile 340a and/or menu profile 340b in order to customize screen content for the particular user, as explained below.

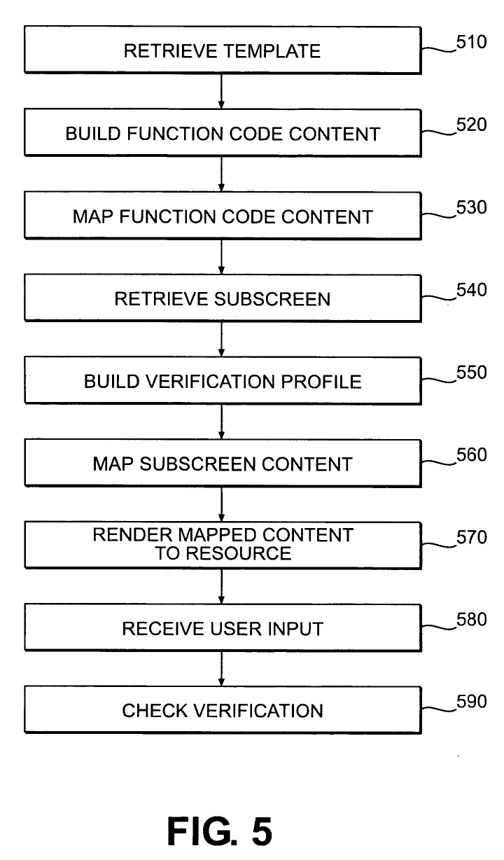

At 450, business logic layer 300 may determine whether the next transaction step requires foreground processing (i.e., requires presentation of physical screen data to a user). If the next transaction step determined at 450 does not require foreground processing (450: No), then business logic layer 300 may skip foreground processing and instead proceed to background processing at 480. If the next transaction step determined at 450 does require foreground processing (450: Yes), then business logic layer 300 may execute the foreground step (at 460) by rendering an appropriate display to the particular presentation device 100_{N}. Exemplary processing of a foreground step is described in further detail below with respect to FIG. 5.

FIG. 5 is a flow diagram of an exemplary method for executing a foreground step, consistent with an embodiment of the present invention. The method illustrated in FIG. 5 is described with reference to exemplary screen displays illustrated in FIGS. 6A-E.

At 510, user interface layer 200 may retrieve template 246 from display profile 244 for the particular presentation device 100_{N}. Alternatively, user interface layer 200 may look up the appropriate template 246 in database 240, based on the dimensions and/or type of screen 122 indicated by display profile 244.

At 520, function code content builder 310b may build an appropriate function code content and transmit this content to user interface layer 200. For example, function code content builder 310b may examine function code profile 340a to determine whether the particular user has specified a preferred assignment of a function code or codes for the next transaction step. If a preferred assignment of function codes is specified in function code profile 340a, then function code content builder 310b may build the function code content based on function code profile 340a. Business logic layer 300 may then transmit the function code content to user interface layer 200.

At 530, rendering process 220 may map the function code content transmitted by business logic layer 300 into the function code areas 246b of template 246. In this respect, template 246 for a particular presentation device 100_{N} may define graphical or character fields (e.g., field 246b) that may be correlated with a particular function code. Function code profile 340a may thus define which function code is to be mapped to the appropriate field of any particular display of a presentation device 100_{N}. Based on the mapping defined by template 246 and function code profile 340a, user interface layer 200 may map the appropriate function code content to the appropriate field 246b for the display of appropriate text in field 246b for any transaction step of the enterprise software application. If a particular function code is not used in a particular transaction step, user interface layer 200 may disable the pushbutton corresponding to the unused function code.

At 540, rendering process of 220 may retrieve the appropriate sub-screen 248 for the next transaction step. For example, rendering process 220 may retrieve the appropriate sub-screen 248 for the transaction step from database 240.

At 550, verification content builder 310a may build appropriate verification content for the next transaction step. Verification content builder 310a may examine verification profile 330 to determine whether the content provider has specified a field or fields that are to be verified in the next transaction step. For example, verification profile 330 may indicate that a particular output field 248b corresponding to, e.g., a source identifier in FIG. 6D, is to be verified. If verification profile 330 indicates that one or more fields are to be verified, then verification content builder 310b may build the verification content based on verification profile 330. Business logic layer 300 may then transmit the verification content to user interface layer 200.

At 560, rendering process 220 of user interface layer 200 may map data received from application interface 370 into the appropriate output fields 248b of sub-screen 248. The data received from application interface 370 may be correlated with particular output fields 248b within sub-screen 248 according to display profile 244. For example, rendering process 220 may correlate a source identifier fetched from application interface 370 by data fetch process 320b with the appropriate output field 248b within sub-screen 248 (see FIG. 6D). Accordingly, based on the type of data received from application interface 370, user interface layer 200 may map the appropriate sub-screen content to the appropriate field of any particular display of a presentation device 100_{N}.

At 570, rendering process 220 may render the mapped sub-screen content and function code content to the particular presentation device 100_{N}. The rendered content may then be received by presentation device manager 135, and rendered to display 122, e.g., as in the various displays depicted in FIGS. 6A-E.

At 580, translation process 210 of business logic layer 300 may receive any user input (e.g., data or commands) needed to execute the next transaction step. The user input may include, for example, data entered into one or more output fields 248b using one or more data entry devices 110 of the particular presentation device 100_{N}. For example, as illustrated in FIG. 6D, the user has entered data in the “Dest. HU” input field. Presentation device manager 135 may transmit the user input data to execution system 150 via system link 130. Translation process 210 may then translate the user input to a form appropriate for business logic layer 300. For example, translation process 210 may translate user input from bar code or RFID scanner 116 into a common form usable by business logic layer 300.

At 590, if a particular field is to be verified, then verification process 380 may verify the data in the appropriate fields. Processing may then return to FIG. 4 (at 470).

At 470, verification process 380 may check to see whether all of the fields specified in verification profile 330 have been verified. If the user input matches verification profile control values provided by application interface 370 (470: Yes), then verification process 380 may update graphical or character content 248a to indicate that the particular output field 248b has been verified. For example, verification process 380 may close the verification field, thus disallowing further entry in the verified field. Processing may then continue to 480. If the user input does not match the verification profile control values provided by application interface 370 (470: No), then business logic layer may return to 460 for additional foreground processing. For example, business logic layer 300 may update sub-screen 248 to indicate an error in the particular output field 248b. For example, verification content builder 310a may clear the user input from the unverified field and/or display an error message, or otherwise highlight the unverified field.

At 480, transaction processes 320 may execute any content provider processing of the user input necessary to complete the transaction step. For example, data distribution process 320c may execute a record destination step within a putaway transaction by recording the destination input by the user (and verified, if necessary, at 470) in an appropriate record within application interface 370.

At 490, business logic layer may determine if the executed transaction step was the final step of a logoff transaction. If so (490: yes), then execution system 150 may cease processing transactions with presentation device 100_{N} (at 495). If not (490: No), then business logic layer 300 may save the executed step as the last transaction step and return to 430 in order to determine the next transaction step.

Accordingly, as disclosed, systems and methods are provided for customizing user interfaces and for facilitating the rendering of user interfaces so as to be suitable for display on a variety of physical display screens. The foregoing description of possible implementations consistent with the present invention does not represent a comprehensive list of all such implementations or all variations of the implementations described. The description of only some implementations should not be construed as an intent to exclude other implementations. One of ordinary skill in the art will understand how to implement the invention in the appended claims in may other ways, using equivalents and alternatives that do not depart from the scope of the following claims.

The systems and methods disclosed herein may be embodied in various forms including, for example, a data processor, such as a computer that also includes a database. Moreover, the above-noted features and other aspects and principles of the present invention may be implemented in various environments. Such environments and related applications may be specially constructed for performing the various processes and operations according to the invention or they may include a general-purpose computer or computing platform selectively activated or reconfigured by code to provide the necessary functionality. The processes disclosed herein are not inherently related to any particular computer or other apparatus, and may be implemented by a suitable combination of hardware, software, and/or firmware. For example, various general-purpose machines may be used with programs written in accordance with teachings of the invention, or it may be more convenient to construct a specialized apparatus or system to perform the required methods and techniques.

Systems and methods consistent with the present invention also include computer readable media that include program instruction or code for performing various computer-implemented operations based on the methods and processes of the invention. The media and program instructions may be those specially designed and constructed for the purposes of the invention, or they may be of the kind well known and available to those having skill in the computer software arts. Examples of program instructions include, for example, machine code, such as produced by a compiler, and files containing a high level code that can be executed by the computer using an interpreter.

What is claimed is:

1. A method, performed by a computer system, for rendering content to a display screen of one device of a plurality of devices utilizing an application run by the system, the method comprising:
identifying the one device from among the plurality of devices;
receiving attributes of the screen of the one device;
retrieving a template for the screen based on the received attributes;
receiving screen content from the application;
mapping the received screen content into the template; and
rendering the mapped content to the device for display on the screen.

2. The method of claim 1, wherein identifying the one device from among the plurality of devices includes identifying a network address of the device.

3. The method of claim 1, wherein receiving attributes of the screen of the one device includes receiving at least one of a display screen type and a dimension of the screen.

4. The method of claim 1, wherein receiving screen content from the application includes receiving at least one of sub-screen content and function code content.

5. The method of claim 1, wherein mapping the screen content into the template includes mapping sub-screen content into the template.

6. The method of claim 5, wherein mapping sub-screen content includes correlating particular sub-screen content with a particular field of the template.

7. The method of claim 1, wherein mapping the screen content into the template includes mapping function code content into the template.

8. The method of claim 7, wherein mapping function code content includes correlating particular function code content with a particular field of the template.

9. The method of claim 1, further comprising:
identifying a user of the device;
receiving personal preferences of the user; and
generating the screen content based on the personal preferences.

10. The method of claim 9, wherein receiving personal preferences of the user includes receiving at least one of a function code preference and a menu preference.

11. The method of claim 1, wherein the application is a warehouse management application.

12. The method of claim 1, wherein the device includes one of a barcode scanner and an RFID scanner.

13. A computer system for rendering content to a display screen of one device of a plurality of devices utilizing an application run by the system, the system comprising:
means for identifying the one device from among the plurality of devices;
means for receiving attributes of the screen of the one device;
means for retrieving a template for the screen based on the received attributes;
means for receiving screen content from the application;
means for mapping the received screen content into the template; and
means for rendering the mapped content to the device for display on the screen.

14. The system of claim 13, wherein the means for identifying the one device from among the plurality of devices includes means for identifying a network address of the device.

15. The system of claim 13, wherein the means for receiving attributes of the screen of the one device includes means for receiving at least one of a display screen type and a dimension of the screen.

16. The system of claim 13, wherein the means for receiving screen content from the application includes means for receiving at least one of sub-screen content and function code content.

17. The system of claim 13, wherein the means for mapping the screen content into the template includes means for mapping sub-screen content into the template.

18. The method of claim 17, wherein the means for mapping sub-screen content includes means for correlating particular sub-screen content with a particular field of the template.

19. The method of claim 13, wherein the means for mapping the screen content into the template includes means for mapping function code content into the template.

20. The method of claim 19, wherein the means for mapping function code content includes means for correlating particular function code content with a particular field of the template.

21. The system of claim 13, further comprising:
means for identifying a user of the device;
means for receiving personal preferences of the user; and
means for generating the screen content based on the personal preferences.

22. The system of claim 21, wherein the means for receiving personal preferences of the user includes means for receiving at least one of a function code preference and a menu preference.

23. The system of claim 13, wherein the application is a warehouse management application.

24. The system of claim 13, wherein the device includes one of a barcode scanner and an RFID scanner.

25. A computer-readable medium containing instructions for performing a method for rendering content to a display screen of one device of a plurality of devices utilizing an application run by a system, the method comprising:
identifying the one device from among the plurality of devices;
receiving attributes of the screen of the one device;
retrieving a template for the screen based on the received attributes;
receiving screen content from the application;
mapping the received screen content into the template; and
rendering the mapped content to the device for display on the screen.

26. The computer-readable medium of claim 25, wherein identifying the one device from among the plurality of devices includes identifying a network address of the device.

27. The computer-readable medium of claim 25, wherein receiving attributes of the screen of the one device includes receiving at least one of a display screen type and a dimension of the screen.

28. The computer-readable medium of claim 25, wherein receiving screen content from the application includes receiving at least one of sub-screen content and function code content.

29. The computer-readable medium of claim 25, wherein mapping the screen content into the template includes mapping sub-screen content into the template.

30. The computer-readable medium of claim 29, wherein mapping sub-screen content includes correlating particular sub-screen content with a particular field of the template.

31. The computer-readable medium of claim 25, wherein mapping the screen content into the template includes mapping function code content into the template.

32. The computer-readable medium of claim 31, wherein mapping function code content includes correlating particular function code content with a particular field of the template.

33. The computer-readable medium of claim 25, further comprising:
identifying a user of the device;
receiving personal preferences of the user; and
generating the screen content based on the personal preferences.

34. The computer-readable medium of claim 33, wherein receiving personal preferences of the user includes receiving at least one of a function code preference and a menu preference.

35. The computer-readable medium of claim 25, wherein the application is a warehouse management application.

36. A method for rendering content to respective display screens of a plurality of devices utilizing an application run by the system, wherein the display screens include at least one of display screens of different types and a display screens of different dimensions, the method comprising:
providing a template data structure defining one or more data fields for displaying rendered content on a display screen of a particular type and size;
receiving an indication of the type and size of the display screen of a particular device;
retrieving the template data structure for the screen based on the received type and size;
generating screen content;
translating the generated screen content, based on the template data structure, to a format compatible with the respective display screens of the plurality of devices; and
rendering the translated content on the display screens of the plurality of devices.

37. A system for rendering content to respective display screens of a plurality of devices utilizing an application run by the system, wherein the display screens include at least one of display screens of different types and a display screens of different dimensions, the system comprising:
a user interface layer for receiving user input data from the plurality of devices and for rendering content to the plurality of devices in a format compatible with the respective display screens of the plurality of devices;
a template data structure defining one or more data fields for displaying rendered content on a particular display screen of a particular device;
a business logic layer for generating content to be rendered to each device by the user interface layer;
wherein the user interface layer receives the generated content and translates the generated content, based on the template data structure, to a format compatible with the respective display screens of the plurality of devices.

38. A computer-readable medium containing instructions for performing a method for rendering content to respective display screens of a plurality of devices utilizing an application run by the system, wherein the display screens include at least one of display screens of different types and a display screens of different dimensions, the method comprising:
providing a template data structure defining one or more data fields for displaying rendered content on a display screen of a particular type and size;
receiving an indication of the type and size of the display screen of a particular device;
retrieving the template data structure for the screen based on the received type and size;
generating screen content;
translating the generated screen content, based on the template data structure, to a format compatible with the respective display screens of the plurality of devices; and
rendering the translated content on the display screens of the plurality of devices.
